(19) United States
(12) Patent Application Publication
(10) Pub. No.: US 2013/0157006 A1
(43) Pub. Date: Jun. 20, 2013

(54) METHOD FOR MAKING MAGNESIUM/MAGNESIUM ALLOY-AND-RESIN COMPOSITE AND MAGNESIUM/MAGNESIUM ALLOY-AND-RESIN COMPOSITE THEREOF

(71) Applicants: CHENG-SHI CHEN, New Taipei (TW); DAI-YU SUN, Shenzhen City (CN); YUAN-YUAN FENG, Shenzhen City (CN); KONG-TING LI, Shenzhen City (CN)

(72) Inventors: CHENG-SHI CHEN, New Taipei (TW); DAI-YU SUN, Shenzhen City (CN); YUAN-YUAN FENG, Shenzhen City (CN); KONG-TING LI, Shenzhen City (CN)

(73) Assignees: HON HAI PRECISION INDUSTRY CO., LTD., New Taipei (TW); HONG FU JIN PRECISION INDUSTRY (ShenZhen) CO., LTD., Shenzhen City (CN)

(21) Appl. No.: 13/414,144

(22) Filed: Mar. 7, 2012

(30) Foreign Application Priority Data
Dec. 15, 2011 (CN) 201110420301.6

(51) Int. Cl. B32B 3/30; B05D 3/10; B32B 3/26

(52) U.S. Cl. 428/141; 428/312.8; 427/532

(57) ABSTRACT

A magnesium/magnesium alloy-and-resin composite includes a magnesium/magnesium alloy substrate, and at least a resin composition coupled to a surface of the substrate. The surface of the substrate is formed with a plurality of pores having a diameter having a range of about 70 nm-400 nm and a depth having a range of about 60 nm-800 nm. The resin composition contains crystalline thermoplastic synthetic resins. A method for making the magnesium/magnesium alloy-and-resin composite is also described.

### BACKGROUND

1. Technical Field

The present disclosure relates to a method for making a magnesium/magnesium alloy-and-resin composite, and a magnesium/magnesium alloy-and-resin composite made by the method.

2. Description of Related Art

Adhesives, for combining heterogeneous materials in the form of a metal and a synthetic resin are in demand in a wide variety of technical fields and industries, such as the automotive and household appliance fields. However, the bonding strength of the metal to resin is weak. Furthermore, adhesives are generally only effective in a narrow temperature range of about −50° C. to about 100° C., which means they are not suitable in applications where operating or environmental temperatures may fall outside the range. Therefore, other bonding methods have been applied that do not involve the use of an adhesive. One example of such methods is by forming bonds through injection molding or other similar process. However, the bonding strength of the metal and resin can be further improved.

Therefore, there is room for improvement within the art.

### BRIEF DESCRIPTION OF THE FIGURES

Many aspects of the disclosure can be better understood with reference to the following figures. The components in the figures are not necessarily drawn to scale, the emphasis instead being placed upon clearly illustrating the principles of the disclosure. Moreover, in the drawings like reference numerals designate corresponding parts throughout the several views.

FIG. 1 is a cross-sectional view of an exemplary embodiment of a magnesium/magnesium alloy-and-resin composite.

FIG. 2 is a scanning electron microscopy view of an exemplary embodiment of a magnesium/magnesium alloy substrate being chemically etched.

FIG. 3 is a scanning electron microscopy view of an exemplary embodiment of a magnesium/magnesium alloy substrate being electrochemically treated.

FIG. 4 is a cross-sectional view of a mold of the composite shown in FIG. 1.

### DETAILED DESCRIPTION

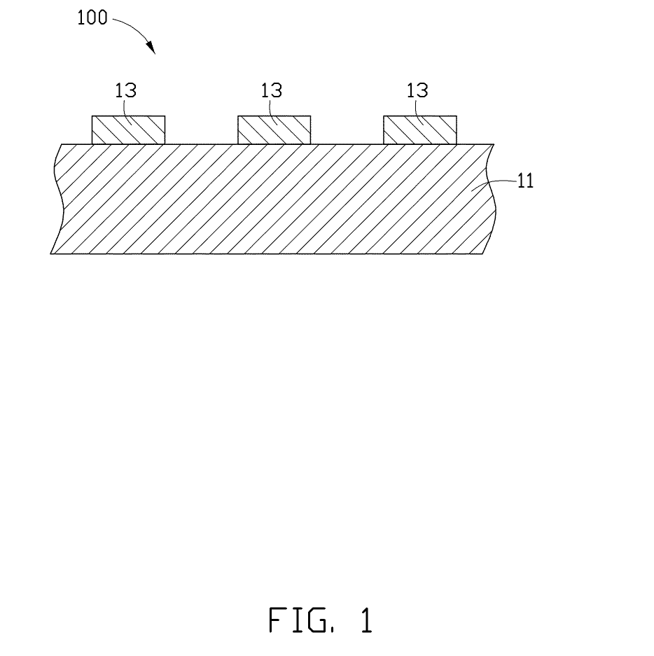

Referring to FIG. 1, according to an exemplary embodiment, a method for making a composite 100 may include the following steps:

A magnesium/magnesium alloy substrate 11 is provided.

The substrate 11 is ultrasonic cleaned using anhydrous ethanol and acetone respectively, and then rinsed.

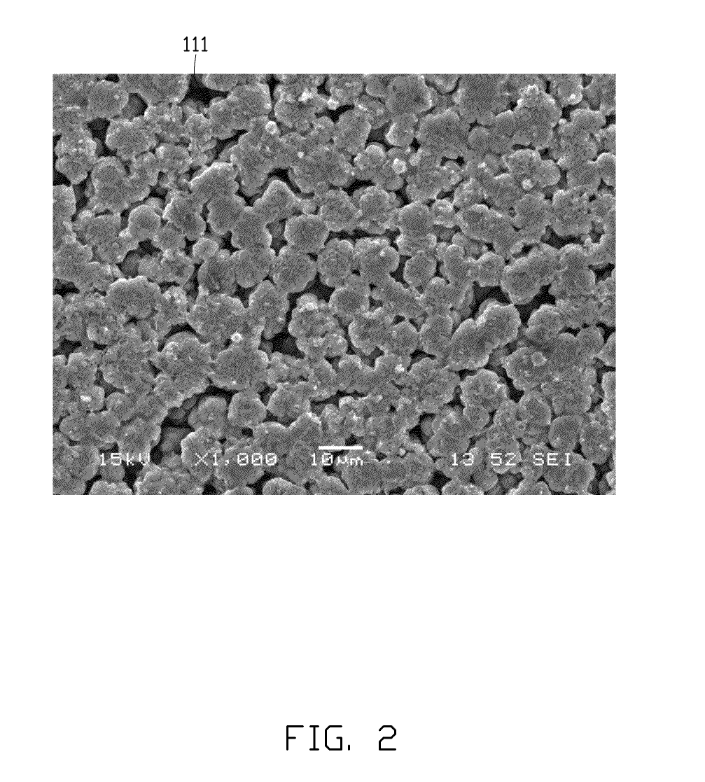

The substrate 11 is chemically etched twice. First, the substrate 11 is dipped in a sodium carbonate water solution to be etched. The sodium carbonate water solution has a mass concentration of about 1%-5%. Second, the substrate 11 is dipped in a citrate hydrate water solution to be etched. The citrate hydrate water solution has a mass concentration of about 0.1%-0.5%. During the two etching processes, partial metal on the surface of the substrate 11 chemically reacts with the components of the water solutions and dissolved in the water solutions, thus the surface of the substrate 11 is roughened. After the etching process, a plurality of recesses 111 is formed in the surface of the substrate 11 (referring to FIG. 2).

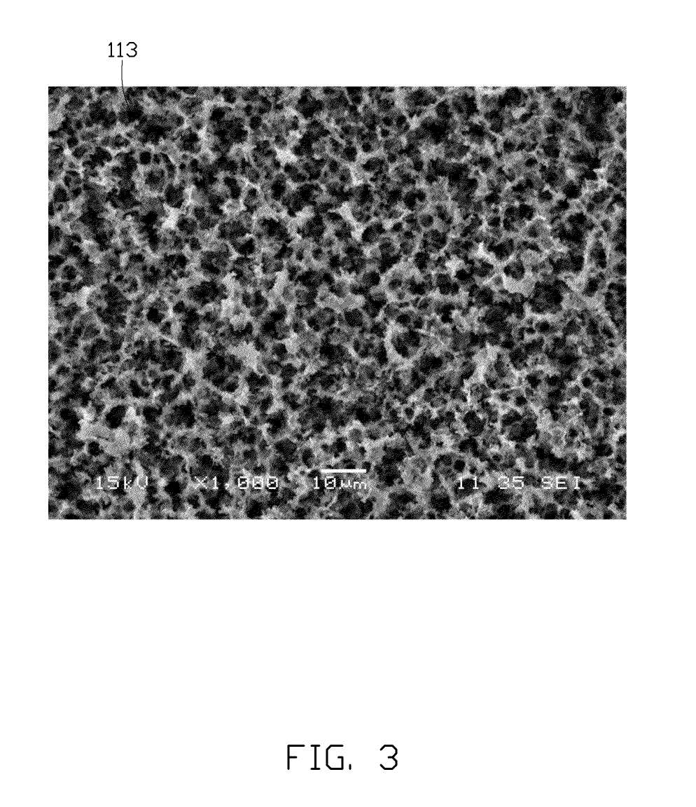

The substrate 11 is electrochemically treated. The electrochemical treating process may be carried out in a water solution containing sodium silicate, potassium hydroxide, and citric acid, with the substrate 11 being an anode, and a stainless steel board being a cathode. The sodium silicate may have a mass concentration of about 20 g/L-50 g/L. The potassium hydroxide may have a mass concentration of about 10 g/L-40 g/L. The citric acid may have a mass concentration of about 5 g/L-20 g/L. The electric current density through the water solution may be about 0.2 milliampere per square centimeter (mA/cm²)-0.5 mA/cm². Electrochemically treating the substrate 11 may last for about 9 minutes (min)-18 min After the electrochemical treating process, the surface of the substrate 11 is roughened and forms a coral reef like structure (referring to FIG. 3). Simultaneously, a plurality of pores 113 are formed in the surface of the substrate 11. The pores 113 have a diameter having a range of about 70 nm-400 nm.

Next, the substrate 11 is rinsed in water and then dried.

In the exemplary embodiment, the chemical etching process and the electrochemical treating process are all carried out at a room temperature, that is, the water solutions of the two processes are not heated.

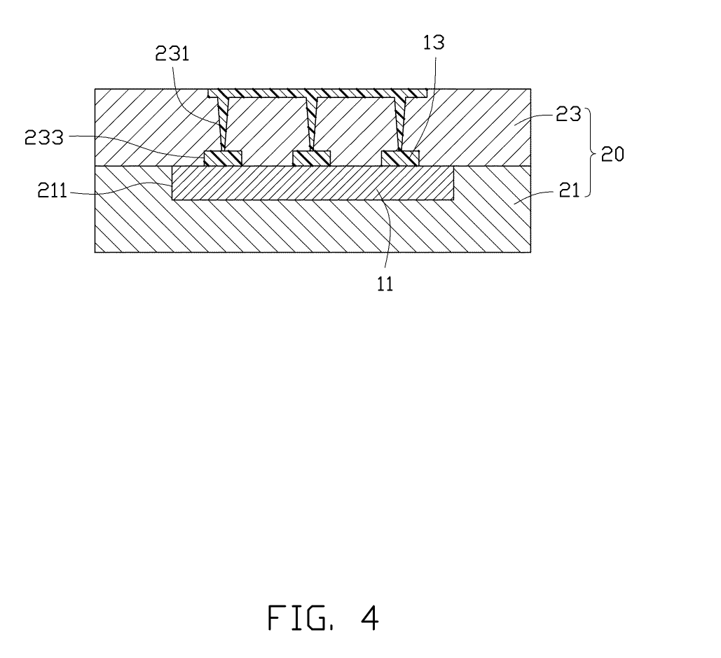

Referring to FIG. 4, an injection mold 20 is provided. The injection mold 20 includes a core insert 23 and a cavity insert 21. The core insert 23 defines several gates 231, and several first cavities 233. The cavity insert 21 defines a second cavity 211 for receiving the substrate 11. The substrate 11 having the pores 113 is located in the second cavity 211, and molten resin is injected through the gates 231 to coat the surface of the substrate 11 and fill the pores 113, and finally fill the first cavities 233 to form resin compositions 13, as such, the composite 100 is formed. The molten resin may be crystalline thermoplastic synthetic resins having high fluidity, such as polyphenylene sulfide (PPS) containing fiberglass.

Referring to FIG. 1 again, the magnesium/magnesium alloy-and-resin composite 100 formed by the method above includes a magnesium/magnesium alloy substrate 11, and resin compositions 13 formed on the substrate 11.

The surface of the substrate 11 is roughened and forms a coral reef like structure, and forms a plurality of pores 113 therein. The pores 113 have a diameter having a range of about 70 nm-400 nm, and a depth having a range of about 60 nm-800 nm.

The resin compositions 13 are coupled to the roughened and porous surface of the substrate 11. During the molding process, molten resin coats the roughened and porous surface of the substrate 11 and fills the pores 113, thus strongly bonding the resin compositions 13 to the substrate 11. Compared to the conventional injection molding process in which the magnesium/magnesium alloy substrate is not chemically etched and electrochemically treated, the composite 100 in the exemplary embodiment has a much stronger bond between the resin compositions 13 and the substrate 11 (about quintuple the bonding force).

The resin compositions 13 may be made up of crystalline thermoplastic synthetic resins having high fluidity. In the exemplary embodiment, PPS containing fiberglass is selected as the molding materials for the resin compositions 13. These resin compositions 13 can bond firmly with the substrate 11.

Tensile strength and shear strength of the composite 100 have been tested. The tests indicated that the shear strength of the composite 100 was more than 20 MPa, and the tensile strength of the composite 100 was greater than 10 MPa.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A magnesium/magnesium alloy-and-resin composite, comprising:
a magnesium/magnesium alloy substrate, a surface of the substrate being formed with a plurality of pores having a diameter having a range of about 70 nm-400 nm and a depth having a range of about 60 nm-800 nm; and
at least a resin composition coupled to the surface of the substrate, the resin composition containing crystalline thermoplastic synthetic resins.

2. The composite as claimed in claim 1, wherein the surface of the substrate is a roughened surface having a coral reef like structure.

3. The composite as claimed in claim 1, wherein the resin composition fills the pores of the substrate.

4. The composite as claimed in claim 1, wherein the resin composition is a molded crystalline thermoplastic synthetic resin composition.

5. The composite as claimed in claim 1, wherein the crystalline thermoplastic synthetic resin is polyphenylene sulfide containing fiberglass.

6. A method for making a magnesium/magnesium alloy-and-resin composite, comprising:
providing a magnesium/magnesium alloy substrate;
chemically etching the substrate using sodium carbonate water solution and citrate hydrate water solution respectively to rough a surface of the substrate and form a plurality of recesses in the surface;
electrochemically treating the substrate using a water solution containing sodium silicate, potassium hydroxide, and citric acid to form a plurality of pores in the surface, the pores having a diameter having a range of about 70 nm-400 nm and a depth having a range of about 60 nm-800 nm; and
inserting the substrate in a mold and molding crystalline thermoplastic synthetic resin on the surface of the substrate to form the composite.

7. The method as claimed in claim 6, wherein electrochemically treating the substrate is carried out in the water solution for about 9 minutes-18 minutes with the substrate being an anode, a stainless steel board being a cathode, the mass concentration of the sodium silicate is about 20 g/L-50 g/L, the mass concentration of the potassium hydroxide is about 10 g/L-40 g/L, and the mass concentration of the citric acid is about 5 g/L-20 g/L, electric current density through the water solution is about 0.2 mA/cm²-0.5 mA/cm².

8. The method as claimed in claim 6, wherein the sodium carbonate water solution has a mass concentration of about 1%-5%.

9. The method as claimed in claim 6, wherein the citrate hydrate water solution has a mass concentration of about 0.1%-0.5%.

10. The method as claimed in claim 6, wherein the crystalline thermoplastic synthetic resin is polyphenylene sulfide containing fiberglass.

11. The method as claimed in claim 6, wherein the surface of the substrate is roughened and forms a coral reef like structure after the electrochemical treating process.

12. The method as claimed in claim 6, wherein the crystalline thermoplastic synthetic resin fills the pores of the substrate.

13. A magnesium/magnesium alloy-and-resin composite, comprising:
a magnesium/magnesium alloy substrate, a surface of the substrate being formed with a plurality of pores having a diameter having a range of about 70 nm-400 nm and a depth having a range of about 60 nm-800 nm; and
at least a molded resin composition coupled to the surface of the substrate, the resin composition containing crystalline thermoplastic synthetic resins.
